(19) United States
(12) Patent Application Publication
(10) Pub. No.: US 2004/0194154 A1
(43) Pub. Date: Sep. 30, 2004

(54) Removable storage device media player

(76) Inventors: Michael J. Meadors, Round Rock, TX (US); Balaji Mittapali, Austin, TX (US)

Correspondence Address: HAMILTON & TERRILE, LLP, P.O. BOX 203518, AUSTIN, TX, 78720, US

(21) Appl. No.: 10/397,604

(22) Filed: Mar. 26, 2003

(51) Int. Cl. H04N 7/16; H04N 7/173

(52) U.S. Cl. 725/153; 725/134; 725/142

(57) ABSTRACT

A stand-alone digital media player is provided in connection with a removable media storage device which includes an audio panel (start/stop, forward, reverse, eject buttons), audio control circuitry, audio output and power source. The removable media storage device may be used as an internal/external storage device and as a digital media player by virtue of audio playback functionality added to the removable media storage device and/or a portable adapter housing coupled to the removable media storage device. Where the power source is a rechargeable batter included in the removable media storage device, the battery will recharge when attached to the portable computer when running on AC Power and provide additional backup power to the portable computer when needed.

### BACKGROUND OF THE INVENTION

1. Field of the Invention

The present invention relates in general to the field of information handling system accessories for of digital media playback. In one aspect, the present invention relates to a stand-alone removable media storage device for playing digital music.

2. Description of the Related Art

As the value and use of information continues to increase, individuals and businesses seek additional ways to process and store information. One option available to users is information handling systems. An information handling system generally processes, compiles, stores and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated and how quickly and efficiently the information may be processed, stored or communicated. The variations in information handling systems allow for information handling systems to be general or configured for a specific user or specific use such as financial transaction processing, airline reservations, enterprise data storage or global communications. In addition, information handling systems may include a variety of hardware and software components that may be configured to process, store and communicate information and may include one or more computer systems, data storage systems, and networking systems.

Further limitations and disadvantages of conventional systems will become apparent to one of skill in the art after reviewing the remainder of the present application with reference to the drawings and detailed description which follow.

### SUMMARY OF THE INVENTION

In accordance with the present invention, a removable disk drive (such as an internal/external CD-ROM drive) for a portable computer is provided as a stand-alone music player having an audio panel (start/stop, forward, reverse, eject buttons), audio output, and rechargeable battery which, when detached from the computer, works as a stand-alone CD or MPG disk player. In a selected embodiment, the rechargeable battery is included in the removable disk drive, and recharges when attached to the portable computer when running on AC power.

In accordance with an alternate embodiment of the present invention, a removable storage device media player is provided for playing media data stored on optical or magnetic disks that are read by a removable or internal/external disk drive configured for use in a portable computer. The media data may contain audio data, video data or a combination of audio and video data. The removable disk drive includes a data bus terminal (such as an IDE or SCSI or ATAPI compliant bus) and an analog output terminal, and operates through these terminals as a storage drive when the removable disk drive is inserted into a drive bay of a portable computer. When not inserted into the drive bay of a portable computer, the removable disk drive is operable to play media data stored on the disks by virtue of a playback control panel (such as start/stop, forward, reverse, eject and/or volume control switches), battery supply, audio or visual output devices (such as headphone jacks, external speakers or video display screens) and analog control circuitry. Any of all of these additional playback components may be implemented in the removable disk drive housing, or may instead be provided in an attachable adapter unit that connects to the storage drive terminals. However implemented, control signals from the playback control panel are provided to the data bus terminal for controlling the read operations of the removable disk drive. The retrieved audio data is converted to analog form, either by DAC circuitry on the removable disk drive for output on the analog output terminal or by control circuitry in the adapter unit. Likewise, retrieved video data is decompressed with video decoding circuitry (located in either the removable disk drive or the adapter unit) and output on a video display screen (such as an LCD display).

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a stand-alone media player implemented in a removable media storage device.

FIG. 2 shows a digital media player where playback functions are included in an adapter into which a removable media storage device is inserted.

FIG. 3 shows a perspective view of an audio playback adapter attached to the IDE pin end of a removable media storage device.

FIG. 4 shows details of the components included in the audio playback adapter shown in FIG. 3.

FIG. 5 shows an automotive accessory for playing digital media stored on a removable media storage device.

FIG. 6 shows a converter appliance for playing digital media stored on a removable media storage device.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence or data for business, scientific, control or other purposes. For example, an information handling system may be a personal computer, a network storage device or any other suitable device and may vary in size, shape, performance, functionality and price. The information handling system may include random access memory (RAM), one or more processing resources such as a central processing unit (CPU) or hardware or software control logic, ROM and/or other types of nonvolatile memory. Additional components of the information handling system may include one or more disk drives, one or more network ports for communicating with external devices as well as various input and output (I/O) devices, such as a keyboard, a mouse and a video display. The information handling system may also include one or more buses operable to transmit communications between the various hardware components.

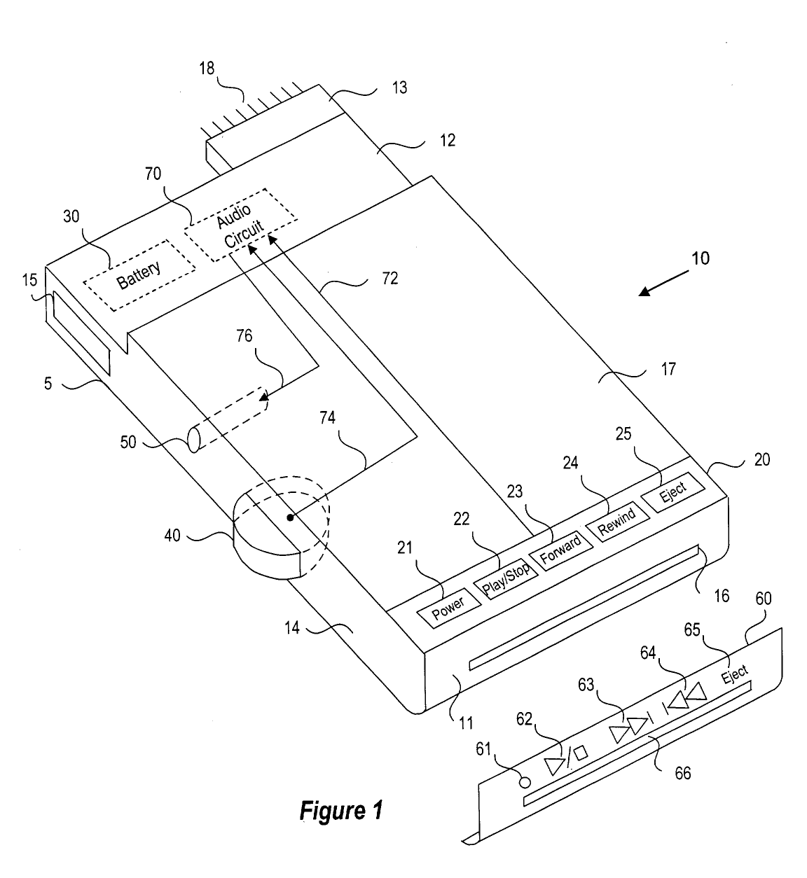

Referring now to FIG. 1, a stand-alone media player 10 is shown implemented in a removable disk drive device 5. Though illustrated in FIG. 1 as a removable CD-ROM or DVD drive for use in connection with a portable laptop or notebook computer (not shown), it will be appreciated that the present invention can be implemented to add media playback functionality to any removable media storage device used with a notebook or laptop computer, such as removable floppy disk drives, zip drives, SuperDisk drives, HiFD drives, Jaz drives, Orb drives, optical disk drives (such as compact disc (CD) and digital versatile disk (DVD) drives, whether read-only or writeable), magneto-optical disk drives, RAMbo drives, MultiLevel CD and DVD drives, blue laser disk drives, holographic data disk drives, fluorescent multi-layer disk drives, etc.

As illustrated in FIG. 1, the removable media storage device 5 is configured for insertion into a drive bay of a portable computer, such as a laptop or notebook computer. As will be understood by those skilled in the art, a removable media storage device 5 includes circuitry for reading digital information from a disk (not shown) and transferring the information to the portable computer through the IDE interface connector 13 which typically includes numerous pins 18 for transferring signal information. In addition, removable media storage device 5 may also include a power connector outlet (not shown) which is used to connect to the portable computer power supply when the storage device 5 is inserted into the portable computer drive bay and to recharge the battery 30 when the storage device 5 is inserted into the portable computer. Removable media storage device 5 may also include an audio connector (not shown) and internal audio conversion circuitry 70 for converting the digital information stored on the disk to analog form so that it can be transferred as audio information through the audio connector.

To add media playback capability, the present invention includes a media playback control functionality within the removable storage device 5 so that media information stored in digital form on the disk can be read, converted to the appropriate media output format and played back by the player 10. In the embodiment depicted in FIG. 1, a power source for the player 10 is provided by a rechargeable battery 30 which is located within the interface housing 12 of the storage device 5. Interface housing portion 12 also includes audio control circuitry 70 which is operable to generate media output signal information. As will be appreciated, digital information stored on a disk is read by the removable media storage drive 5 and converted to analog signal format by audio control circuit 70. Audio control circuit 70 may be included as an additional circuit component to the removable media storage device 5, or may instead be implemented with any existing digital to analog converter circuit component contained within the removable media storage device, such as the circuitry used to generate information provided to the analog connectors.

An audio control circuit, whether included as part of the removable media storage device or provided as additional circuitry, includes a digital-to-analog converter for converting digital information read by the storage device into analog information. In addition, the audio control circuit may employ an audio mixer or audio codec. For example, the analog output of a removable CD-ROM storage device is a common input to an audio mixer, which provides volume control of the CD-ROM outputs. The output of the mixer may be coupled to a power amplifier, which in turn is coupled to speakers or to a headphone jack.

Audio control circuit 70 is electrically connected 72 to an audio panel 20 which provides playback control functionality for the media player 10. As shown in FIG. 1, the audio panel 20 includes control buttons for controlling playback of any disk being read by the storage device, such as a power button 21, a play/stop button 22, a forward button 23, a rewind button 24 and an eject button 25. In accordance with the present invention, the control buttons 21-25 may be implemented as tactile switches, surface mounted microswitches or other input keypad technologies for generating control signals. As illustrated, audio panel 20 is affixed to the top panel 17 of the removable media storage device 5, and the control buttons 21-25 are positioned within the top panel 17 so that the removable media storage device 5 may be inserted into the portable computer and used as a storage disk drive. It will be appreciated that the audio panel 20 may be placed on any surface of the removable media storage device 5, including in the side panel 14 or on any external surface of the interface housing portion 12, so long as the media storage device 5 can be inserted into the portable computer bay.

In accordance with an alternative embodiment, the audio panel functionality is provided with a removable audio panel 60 which includes audio control keys 61-65 for controlling media playback of information stored on the disk which is inserted through opening 66 into the removable media storage drive 5. In accordance with the present invention, the removable media audio panel 60 is detachably connected to the bezel cover surface 11 of the removable media storage drive 5. Alternatively, an audio panel containing playback control input keys may be permanently affixed to the bezel cover surface of the removable media storage device 5.

In addition to receiving control signals from an audio panel, the audio control circuit 70 is also connected 74 to a volume control 40, which is illustrated as a disk switch 40. To facilitate usage of the removable drive player 10 and as a storage device in a portable computer, the volume control 40 is recessed within the side panel 14, or is otherwise flexibly affixed to the storage device 5 so that the volume control disk 40 protrudes from the surface 14 only when the storage device 5 is not inserted into a portable computer.

Analog or audio signal information generated by the audio control circuit 70 is output from the removable drive player 10 in analog form. For example, analog signal information is transmitted over signal line 76 to headphone jack 50. Alternatively, audio signals may be played over external speaker units (not shown) mounted on the interface housing portion 12. Where the present invention is implemented as an audiovideo playback device, video information generated by the media control circuit 70 is displayed on display panel (not shown) affixed within the surface housing of the removable media storage device 5. As will be appreciated, whatever form of media is output, the signal output is controlled by the audio media control circuit 70, acting in concert with the volume control 40 and any control button inputs from an audio panel.

In accordance with the embodiment of the present invention illustrated in FIG. 1, media playback control circuitry is included as part of a removable media storage device so that the device is operable to be inserted within a portable computer for use as a storage device, and is also independently operable as a stand-alone digital media player operating under its own power supply to play back audio and/or video information stored in digital form on a disk that is read by the removable media storage device.

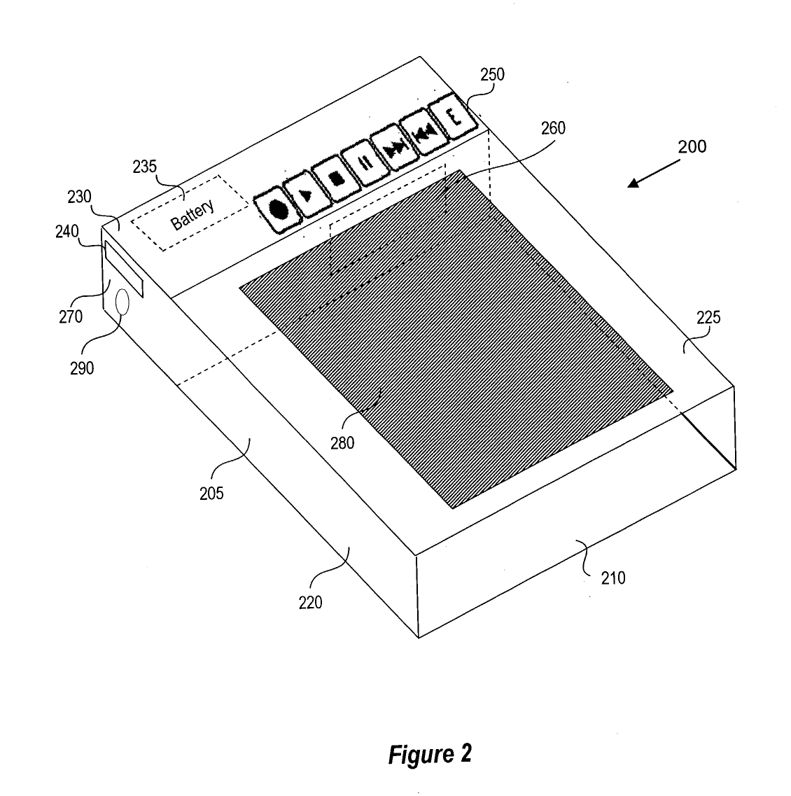

Referring now to FIG. 2, a digital media player is depicted where playback functions are included in a housing into which a removable media storage device is inserted. As depicted, digital media player 200 includes a drive housing portion 205, and an adapted housing portion 270. The drive housing portion 205 includes side panels 220, bottom and top panels 225 and an opening 210 into which is inserted a removable media storage device, such as an internal/external CD or DVD drive which is operable for use with a portable computer. The adapter housing portion 270 includes a drive connector coupling device 260 for connecting to an output of the removable media storage device, such as the IDE interface connector or audio connector outputs. For example, adapter housing portion 270 includes an IDE pin or bus connector 260 through which the digital media player 200 communicates to the removable media storage device. In addition, or in the alternative, other connecting devices are provided for establishing electrical signal connection to the storage device so that digitally stored information on a disk may be read by the storage device for use and playback by the digital media player 200. Media playback functionality is provided by playback control circuit components contained within the adapter housing 270 which includes a power supply and transport control keys for controlling media playback. For example, control panel 250 is provided as part of the adapted housing top panel 230 to control media playback using keypads to control power, play, forward, reverse and other playback functions. In addition, adapted housing 270 includes a power source, such as a rechargeable battery 235 located within a battery slot or chamber 240.

In a selected embodiment, control signals from a control panel 250 and power from the battery 235 are provided or coupled to the removable media storage device through the IDE pin connector 260 to control playback of digital information stored on a disk within the storage device. The control signals from the digital media player 200 interact with digital-to-analog converter (DAC) circuitry contained in a removable media storage device for generating audio signals, causing the digital to analog converter circuitry to generate analog sound information. The analog signals are then transmitted to the adapter housing portion (through the IDE connector 260 or audio connector port) where they are output at the audio output jack 290. As will be appreciated, control panel 250 may further include volume control input and circuitry (not shown) for amplifying the analog signal provided at audio output 290.

While the embodiment depicted in FIG. 2 is shown as using the digital-to-analog converter circuitry in the removable media storage device which generates audio signals, it will be appreciated that the present invention may also be implemented with analog circuitry contained in the adapter housing portion 270 for converting digital information stored on a disk, such as a CD-ROM to analog form suitable for output on the audio output 290.

Where the digital media player 200 is implemented as a video playing device, the drive housing portion 205 may include a video display panel 280, such as an LCD video display positioned on the drive housing top panel 225. The removable media storage device inserted into the media player 200 includes decoding circuitry (such as an MPEG decoder) for generating video signal information, or alternatively, the adapted housing portion 270 includes video processing circuitry for providing the video decode function. In this embodiment, digital information stored on the disk that is read by the removable media storage device would be transmitted through the IDE pin connector 260, and converted by the video decode circuitry (not shown) under control of the control panel 250. The decoded video signals would then be transmitted for display on the video display 280 affixed to the surface of the drive housing. In this embodiment, a stand-alone digital multimedia player is provided for displaying video information stored on a removable media storage device that can also be used as a storage device in a portable computer.

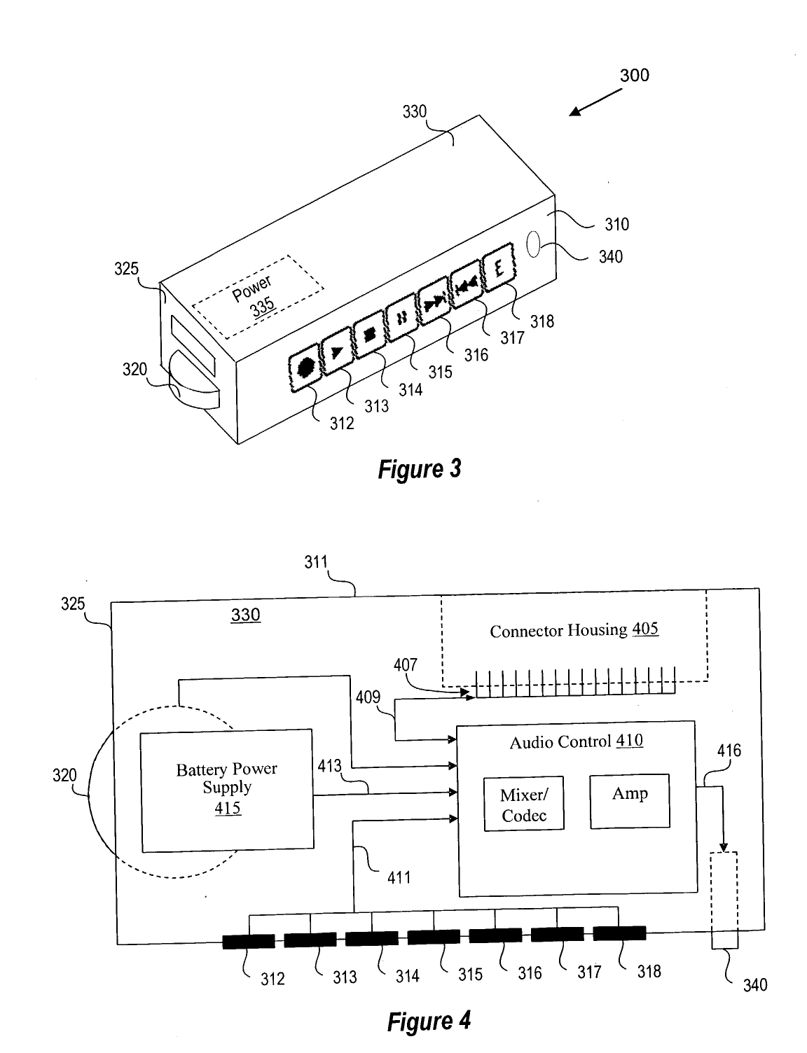

FIG. 3 shows an audio playback converter 300 which is configurable for attachment to the IDE connector interface portion of a removable media storage device. In the depicted embodiment, the converter 300 is affixed to the “back end” portion of a storage device, and provides audio control functionality for generating audio signals based upon digital information stored on a disk that is read by the removable media storage device (not shown).

The audio drive converter 300 includes a bottom and top panel 330, side panels 325 and front panel 310. Audio control key switches 312-318 are provided in the front panel 310. In addition, a volume control 320 is provided. These input controls operate in combination with an internal power supply 335 to generate audio signals for output on the audio jack 340. The audio drive converter 300 is configured for releasable attachment to a removable media storage device, so that input/out connectors on the removable media storage device are electrically connected to audio control circuitry (shown in FIG. 4) contained within the audio drive converter 300. For example, the housing for the audio drive converter 300 is a plastic molded structure having external electronic terminals for connection to an internal/external disk drive device, such as illustrated in FIG. 4.

Referring now to FIG. 4, the components included in an audio playback converter are illustrated. As shown in FIG. 4, the back panel 311 includes a connector, such as IDE pin housing compartment 405, for coupling with a removable medial storage device. In addition or in the alternative, the connector may include a plug for coupling with the audio connector outputs of an internal/external disk drive device. Digital or analog signal information from the removable media storage device is coupled through connector pin(s) 407 over signal input line 409 to an audio control unit 410.

The audio drive converter 300 also includes a battery power supply 415. Power from the battery 415 is applied, along with audio control signals from the audio control unit 410, to drive the removable media storage drive and read digital information from the removable media storage device. Specific playback functionality is provided through audio control key switches 312-318 which are coupled over input line 411 to the audio control circuit 410. Audio control key switches may be implemented as tactile switches, surface mounted microswitches or other input keypad techniques known to those skilled in the art. In addition, audio control unit 410 includes as an input on the volume input line 412, control information from the volume control 320.

Audio information retrieved from the removable media storage device is provided in analog form over the analog output line 416 to the audio jack output 340. As will be appreciated, analog output signals may be provided directly to the output jack from the removable media storage device when the device contains circuitry for converting digital information into the appropriate output analog format. Alternatively, audio control unit 410 receives digital information from the removable media storage device through the connector pins 407 and converts the information to analog form for output.

In the embodiment depicted in FIG. 3 and 4, audio playback functionality is provided in a compact adapter housing which is affixed to the back end portion of a removable media storage device, such as an intemal/external CD or DVD reader. In accordance with the present invention, the audio control functionality may be implemented in the audio drive converter as audio control unit 410, or may alternatively be implemented with existing DAC circuitry contained in a removable media storage device. In either case, volume control and transport control inputs control how digital information is read from the disk drive and output in analog form. By providing a playback converter with a power supply and control panel functionality, modular internal/external storage devices for portable systems may be used as stand-alone digital audio players when detached from the portable computer.

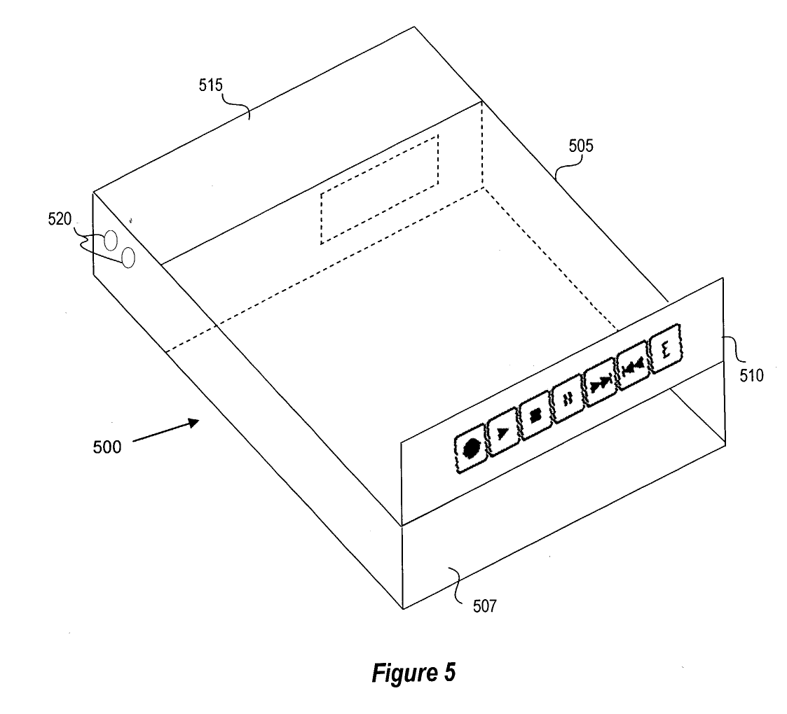

FIG. 5 shows an automotive accessory embodiment of the present invention for playing digital audio stored on a removable media storage device. As depicted in FIG. 5, an automotive accessory 500 for playing digital audio information stored on a removable disk drive includes a sleeve structure 505 for housing or receiving the removable disk drive through opening 507. Upon insertion of the removable disk drive into the sleeve structure 505, the output terminal(s) of the removable disk drive (not shown) are engaged in terminal housing 515. Through connection of the removable disk drive to the terminal housing 515, digital and/or audio signals can be exchanged between the automotive player accessory 505 and the removable disk drive. In particular, playback and volume control keys in an audio control panel 510 that is fixed to the sleeve structure 505 transmit control signals through the terminal housing connector 515 to the removable disk drive using the data pins, such as the IDE terminal pins. In response to the control signals, the removable disk drive retrieves the digital audio information from the storage disk for output through the terminal housing connector 515. As will be appreciated, the retrieved audio information can be provided in either digital or analog form, using DAC conversion circuitry contained either within the removable disk drive or the automotive player accessory 505. However generated, the analog signal information is output from the automotive accessory player at audio output terminal 520 for connection to the automobile speakers. In addition, it will be appreciated that the automotive accessory player 505 uses power supplied by the automobile, such as an automobile battery system (not shown). In accordance with the present invention, the audio control panel 510 may be affixed to the sleeve structure 505 for the automobile accessory player 500. Alternatively, the audio control panel can be affixed to the removable disk drive so that control signals generated by the audio control panel are provided directly to the disk drive reader for retrieving audio information that is output through the terminal housing connector 515.

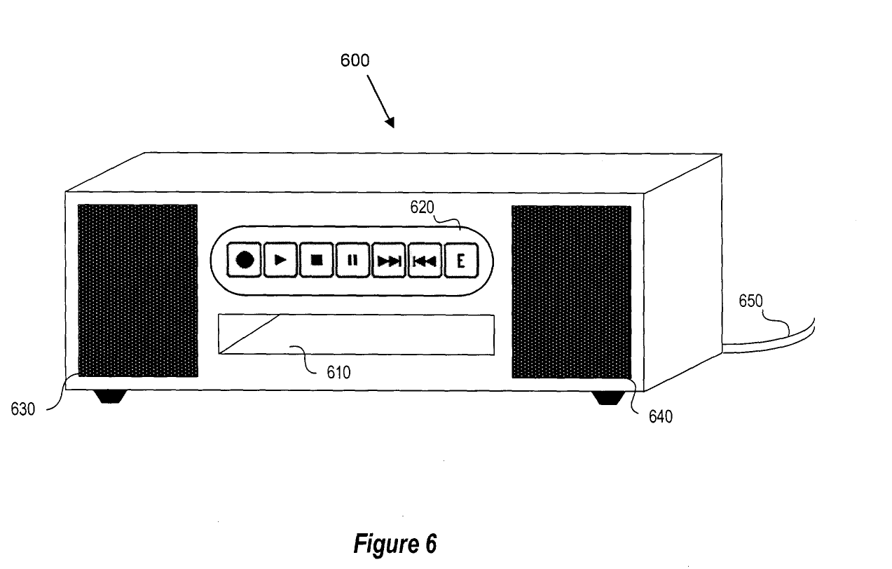

FIG. 6 depicts a converter appliance embodiment of the present invention for playing digital media stored on a removable media storage drive, such as a combination CD/DVD player. As shown in FIG. 6, the appliance adapter 600 includes an opening 610 into which the removable storage device is inserted. The appliance converter 600 includes connector terminals (not shown) in the opening 610 for connection to the terminals of the removable storage device. In addition, the appliance converter 600 includes an AC power adapter and cord 650 for converting and providing electrical power. In the embodiment depicted in FIG. 6, external speakers 630, 640 are provided as part of the appliance adapter structure 600, though it will be appreciated that the speakers 630, 640 may also be physically separate from the appliance adapter. A control panel 620 on the appliance adapter 600 provides control signals for controlling digital media playback. In a selected embodiment, the control signals are communicated to the removable storage disk device through the IDE terminal connectors. In response to these control signals, audio or video data is retrieved from the storage disk and output over the audio connector terminal of the removable storage device as an analog signal. This analog signal is then processed and amplified for output on the external speakers 630, 640.

In accordance with the invention described herein, modular internal/external disk drive devices for portable systems that have little or no use outside of such portable systems can be used as a stand-alone CD player when detached from the portable computer. In this way, a removable storage device can be used as a stand-alone media player and also as a storage drive for a portable computer.

While the system and method of the present invention has been described in connection with the preferred embodiment, it is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A portable digital media player comprising:
a removable media storage device configured for connection as a drive in a portable computer, said removable media storage device comprising a drive reader;
a playback control input affixed to an external surface of the removable media storage device;
an audio output connector;
a battery power supply removably positioned within the removable media storage device for supplying power to the drive reader when the removable media storage device is disconnected from a portable computer; and
a media control unit coupled to the playback control input for processing data read from the drive reader into audio signals for connection to the audio output connector.

2. The portable digital media player of claim 1, where the playback control input comprises a transport panel of input keys for controlling playback of digital information stored in the removable media storage device.

3. The portable digital media player of claim 1, further comprising a display screen affixed to an external surface of the removable media storage device for displaying video information, where the media control unit processes data read from the drive reader into video signals for display as the display screen.

4. The portable digital media player of claim 1, wherein the audio output connector comprises a headphone jack recessed within an external surface of the removable media storage device.

5. The portable digital media player of claim 1, wherein the removable media storage device comprises a disc drive.

6. The portable digital media player of claim 1, wherein the removable media storage device comprises a DVD/CD-RW combination drive.

7. The portable digital media player of claim 1, wherein the media control unit comprises CD audio converter, MPEG audio converter, MS audio converter or WAV converter.

8. The portable digital media player of claim 1, wherein the playback control input is releasably affixed to the bezel cover surface of the removable media storage device.

9. A digital audio converter for playing audio information stored in an internal/external drive that is configured for insertion in a portable computer, said internal/external drive comprising a drive reader and drive terminal for transmitting and receiving signals to and from the drive reader; said digital audio converter comprising:
an interface terminal for connection to the drive terminal of the internal/external drive;
a power supply coupled to the interface terminal for powering operation of the internal/external drive when disconnected from the portable computer;
an audio control panel for generating playback control signals that are transmitted to the interface terminal; and
an audio output coupled to the interface terminal;
wherein the audio information from the internal/external drive is transmitted in analog format to the audio output under control of the playback control signals.

10. The digital audio converter of claim 9, further comprising an audio playback controller coupled to the interface terminal for converting audio information from the internal/external drive into analog signals in response to the playback control signals and transmitting the converted audio signals to the audio output.

11. The digital audio converter of claim 10, wherein the interface terminal comprises an IDE interface connector for connecting to IDE output pins from the internal/external drive, wherein the audio playback controller transmits playback control signals to the internal/external drive over the IDE interface connector to control playback of audio information stored in the internal/external drive.

12. The digital audio converter of claim 10, wherein the interface terminal comprises an audio connector input for connecting to an audio connector output from the internal/external drive, wherein the audio playback controller processes audio signals received from the audio connector input in response to playback control signals.

13. The digital audio converter of claim 9, wherein the interface terminal comprises an IDE interface connector and an audio input connector, such that playback control signals are transmitted to the IDE interface connector for controlling retrieval of audio information by the drive reader, where said audio information is received as an analog signal at the audio input connector and transmitted to the audio output.

14. The digital audio converter of claim 9, wherein the power supply comprises an AC electrical adapter and power cord.

15. The digital audio converter of claim 9, wherein the audio output comprises an audio speaker.

16. The digital audio converter of claim 9, wherein the digital audio converter is an automotive accessory for playing audio information stored in an internal/external drive, such that power supply comprises an automobile battery system, the audio control panel comprises playback and volume control inputs configured for installation in an automobile and the audio output comprises an automobile speaker.

17. A stand-alone digital audio disk player accessory for a portable information handling system for playing audio information stored in digital form on a disk, comprising:
a removable internal/external disk drive storage device for a portable computer, comprising a data terminal;
means for powering the removable internal/external disk drive storage device when the removable intemal/external disk drive storage device is detached from a portable computer;
means for controlling playback of the audio information by transmitting control signals to the data terminal;
means for converting the audio information into analog form in response to the control signals; and
means for outputting the audio information in analog form.

18. The audio disk player accessory of claim 17, wherein the removable internal/external disk drive storage device comprises an analog output terminal and the means for converting audio information comprises digital-to-analog conversion circuitry in the removable internal/external disk drive storage device for generating analog signals that are provided to the analog output terminal.

19. The audio disk player accessory of claim 17, wherein the means for converting audio information comprises an external audio converter device for coupling to the removable internal/external disk drive storage device, comprising analog control circuitry for converting the audio information into analog form in response to the control signals.

20. The audio disk player accessory of claim 17, wherein the removable internal/external disk drive storage device comprises a DVD/CD-RW combination drive for a portable computer, wherein the powering means comprises a rechargeable battery, wherein the means for controlling comprises transport control keys and a volume control, and wherein the means for converting comprises a CD audio converter, MPEG audio converter, MS audio converter or WAV converter.

21. The audio disk player accessory of claim 17, where the means for powering comprises an AC electrical adapter and the means for outputting the audio information comprises an audio speaker.

22. A removable storage device media player, comprising:
an internal/external disk drive for reading media data stored on optical disks comprising a data bus and an analog output terminal, where the internal/external disk drive operates as a storage drive when inserted into a drive bay of a portable computer;
a playback control panel coupled to the data bus for generating control signals for controlling the reading of media data stored on optical disks playback by the internal/external disk drive;
a rechargeable battery for supplying a voltage to the internal/external disk drive when the internal/external disk drive is not inserted into a drive bay of a portable computer;
a headphone output jack; and
a digital-to-analog converter for converting media data into analog signals and coupling the analog signals to the headphone output jack under control of the control signals.

23. The removable storage device media player of claim 22, where the playback control panel, rechargeable battery, headphone output jack and digital-to-analog converter are included in the internal/external disk drive.

24. The removable storage device media player of claim 22, where the playback control panel, rechargeable battery, headphone output jack and digital-to-analog converter are included in an adapter device that attaches to the internal/external disk drive.
